(19) United States
(12) Patent Application Publication
(10) Pub. No.: US 2010/0191415 A1
(43) Pub. Date: Jul. 29, 2010

(54) SYSTEM FOR SUPPORTING MAINTENANCE OF TRAVELLING PATH FOR CONSTRUCTION VEHICLE

(75) Inventor: Yuuki Hara, Kodaira-shi (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Chuo-ku, Tokyo (JP)

(21) Appl. No.: 12/677,737

(22) PCT Filed: Aug. 11, 2008
(86) PCT No.: PCT/JP2008/064413

§ 371 Date: Mar. 11, 2010

(30) Foreign Application Priority Data
Sep. 12, 2007 (JP) 2007-237113

(51) Int. Cl. E01C 23/01; G06F 7/00

(52) U.S. Cl. 701/35

(57) ABSTRACT

The present invention provides a system for supporting maintenance of a travelling path for a construction vehicle, which system enables efficient maintenance of a vehicle travelling path so that drop of loaded stuff, deterioration of durability of the vehicle and the tires, and the like can be effectively prevented. A construction vehicle 11 is provided with a travel position sensor 1, an acceleration sensor 2, and a memory 3 for storing data continually acquired by the sensors during the running of the vehicle, and the system further includes: a controller 5 for reading the aforementioned data out from the memory 3 to express a travelling path graphically, and specifying a maintenance-required travelling path portion in the travelling path thus graphically expressed; and a display portion 6 for displaying the travelling path thus graphically expressed and the maintenance-required travelling path portion extracted therefrom, wherein the controller 5 is adapted to specify a portion of the travelling path corresponding to the acceleration data beyond a predetermined given range of acceleration condition as the maintenance-required travelling path portion.

### TECHNICAL FIELD

The present invention relates to a system for supporting maintenance of a travelling path on which a construction vehicle runs, and in particular, a system which enables efficient maintenance of a travelling path for a construction vehicle.

### PRIOR ART

In a dig site in a mine or the like, ores collected in a digging point are transferred to an ore-collecting point and waste generated during digging is carried to a discard point by using a super-large construction vehicle. A travelling path on which such a construction vehicle as described above runs is provided and continually maintained. For example, in a travelling path having a curve, a bank gradient is provided so that loaded stuff on the vehicle does not drop and/or durability of a vehicle and tires does not deteriorate by the action of relatively large centrifugal force exerted, during running of the vehicle in the left or right hand side direction of the vehicle away from the center of the radius of the curvature of the curve. Other examples of the maintenance of a travelling path for a construction vehicle includes maintaining the path surface in a good condition so that escalated irregularities of the travelling path surface should not cause such troubles as described above, i.e. drop of loaded stuff and/or deterioration of durability of the vehicle and the tires.

### DISCLOSURE OF THE INVENTION

### The Problems to be Solved by the Invention

However, such maintenance as described above of a travelling path of a construction vehicle is generally carried out by relying on the operator's feeling and/or experiences in the past, whereby quite often maintenance which needs urgent action is deferred or the necessity thereof is ignored.

The present invention is contrived in view of the problems described above and has an object of providing a system for supporting maintenance of a travelling path for a construction vehicle, which system enables efficient maintenance of a road surface of the travelling path so that drop of loaded stuff, deterioration of durability of the vehicle and the tires, and the like can be effectively prevented.

### Means for Solving the Problem

In a first aspect <1> of the present invention, a system for supporting maintenance of a travelling path on which a construction vehicle travels, comprises:

a travel position sensor provided in the construction vehicle, for continually acquiring travel position data of the construction vehicle;

an acceleration sensor provided in the construction vehicle, for continually acquiring data of acceleration applied to the construction vehicle;

a memory provided in the construction vehicle, for storing data acquired by the sensors; and

a controller for reading the travel position data out from the memory to express the travelling path graphically, mapping the acceleration data on the travelling path thus graphically expressed, and specifying a portion of the travelling path corresponding to the acceleration data out of a predetermined, given range of acceleration condition, as a maintenance-required travelling path portion.

In a second aspect <2> of the present invention, the system for supporting maintenance of a travelling path for a construction vehicle of the first aspect <1> is characterized in that the acceleration sensor is adapted to detect acceleration in either the left hand side or the right hand side direction of the construction vehicle.

In a third aspect <3> of the present invention, the system for supporting maintenance of a travelling path for a construction vehicle of the first aspect <2> is characterized in that the predetermined, given range of acceleration condition is 0.05 G or less.

In a fourth aspect <4> of the present invention, the system for supporting maintenance of a travelling path for a construction vehicle of the second <2> or third <3> aspect is characterized in that the controller is adapted to calculate a radius of curvature of the maintenance-required travelling path portion, based on the travel position data thereof, and obtain, based on the radius of curvature thus calculated and a predetermined, prescribed vehicle speed at which the vehicle is supposed to run on the maintenance-required travelling path portion, either a bank gradient angle at which acceleration in either the left hand side or the right hand side of the vehicle can be suppressed within the predetermined range of acceleration condition or a new combination of a bank gradient angle and a radius of curvature of the maintenance-required travelling path portion.

In a fifth aspect <5> of the present invention, the system for supporting maintenance of a travelling path for a construction vehicle of the first aspect <1> is characterized in that the acceleration sensor is adapted to detect acceleration in either the upward direction or the downward direction of the construction vehicle.

### EFFECT OF THE INVENTION

According to the first aspect <1> of the present invention, the construction vehicle is provided with the travel position sensor, an acceleration sensor, and a memory for storing data continually acquired by the sensors during the running of the vehicle, and the system further includes: a controller for reading the aforementioned data out from the memory to express the travelling path graphically, and specifying a maintenance-required travelling path portion in the travelling path thus graphically expressed; and a display portion for displaying the travelling path thus graphically expressed and the maintenance-required travelling path portion extracted therefrom, wherein the controller judges that a portion of the travelling path corresponding to the acceleration data beyond a predetermined range of acceleration condition suffers from designing flaw or maintenance flaw of the travelling path and specifies the portion as a maintenance-required travelling path portion. Accordingly, a maintenance-required travelling path portion can be presented on the basis of data in a form of a graphics and an easily understandable manner, whereby maintenance of a travel path can be implemented efficiently and accurately.

According to the second aspect <2> of the present invention, the acceleration sensor is structured to detect acceleration in either the left hand side or the right hand side direction of the construction vehicle. Therefore, a portion of a travel path having a curve, in which portion unusual centrifugal force is exerted on respective portions or loaded stuff of the vehicle running at a predetermined speed, can be specified, so that it can be notified that the portion of the travel path needs maintenance for correcting the bank gradient angle at the curve.

According to the third aspect <3> of the present invention, the predetermined, given range of acceleration condition is 0.05 G or less. Within this acceleration range, loaded stuff is reliably prevented from moving toward the outer side beyond the radius of curvature of the curve due to centrifugal force, whereby loaded stuff is less likely to move and hit various parts of the vehicle to damage or break these parts. Further, within the aforementioned acceleration range, premature tire wear or the like can be suppressed because a large force in the tire widthwise direction is not exerted on a tread surfaces of the tires.

According to the fourth aspect <4> of the present invention, the controller is adapted to calculate a radius of curvature of the maintenance-required travelling path portion, based on the travel position data thereof, and obtain, based on the radius of curvature thus calculated and a predetermined, prescribed vehicle speed at which the vehicle is supposed to run on the maintenance-required travelling path portion, either a bank gradient angle at which acceleration in either the left or right hand side of the vehicle can be suppressed within the predetermined range of acceleration condition or a new combination of a bank gradient and a radius of curvature of the maintenance-required travelling path portion. As a result, a target bank gradient angle for maintenance can be accurately set, based on the data, when a curved portion of a travel path is to be maintained in a good condition.

Further, the acceleration sensor is adapted to detect acceleration in either the upward or the downward direction of the construction vehicle. Therefore, for example, by a setting variation rate of acceleration within a predetermined range as the normal range of acceleration in the upward/downward direction, a portion of the travel path, where irregularities of a surface are severe, can be specified as a maintenance-required travelling path portion. Further, the degree of emergency of maintenance can also be judged according to the magnitude of the variation rate in acceleration.

### BRIEF DESCRIPTION OF THE DRAWINGS

FIG. 1 is a schematic view showing a structure of a system for supporting maintenance of a travelling path for a construction vehicle according to a first embodiment of the present invention.

FIG. 2 is an image showing a travel path, displayed by a display portion of the first embodiment.

FIG. 3 is a schematic view for explaining a bank gradient angle.

FIG. 4 is an image showing a travel path, displayed by a display portion of the second embodiment.

FIG. 5 is a graph showing temporal change in acceleration data obtained by the acceleration sensor for a portion K1 of the travel path.

FIG. 6 is a graph showing temporal change in acceleration data obtained by the acceleration sensor for a portion K2 of the travel path.

### EXPLANATION OF REFERENCES

1 Travel position sensor
2 Acceleration sensor
3 Memory
5 Controller
6 Display portion
10 System for supporting maintenance of a travelling path for a construction vehicle
11 Investigation vehicle
12 Computer installed in vehicle
M0 Travelling path
M1 Portion of travelling path
K0 Travelling path
K1,K2 Portion of travelling path

### BEST MODE FOR IMPLEMENTING THE INVENTION

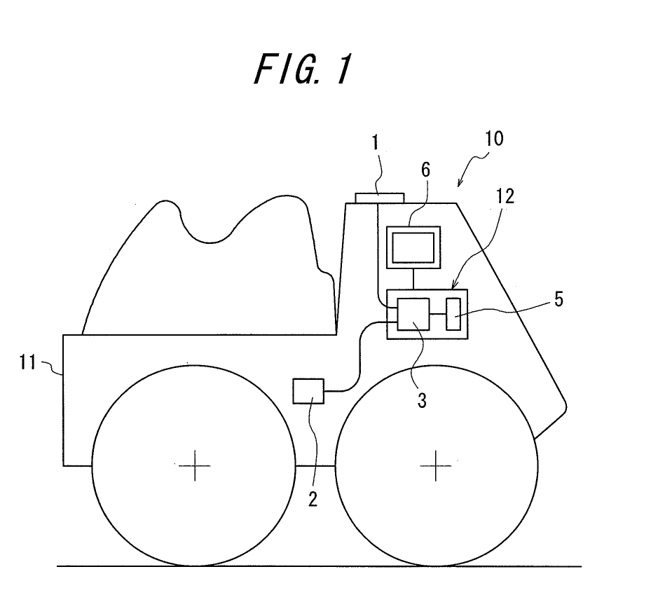

FIG. 1 is a schematic view showing a structure of a system for supporting maintenance of a travelling path for a construction vehicle according to a first embodiment of the present invention. The system 10 for supporting maintenance of a travelling path for a construction vehicle includes a travel position sensor 1, an acceleration sensor 2 and a memory 3 respectively mounted in a construction vehicle 11 for maintenance investigation. The memory 3 stores data continually acquired from the sensors 1, 2 during travelling of the vehicle. The system 10 for supporting maintenance of a travelling path for a construction vehicle further includes: a controller 5 for reading the aforementioned data out from the memory 3 to express the travelling path graphically, and specifying a maintenance-required travelling path portion in the travelling path thus graphically expressed; and a display portion 6 for displaying the travelling path thus graphically expressed and the maintenance-required travelling path portion extracted therefrom.

The controller 5 is adapted to specify a portion of the travelling path corresponding to the acceleration data out of a predetermined given range of acceleration condition as the maintenance-required travelling path portion.

Examples of the memory 3 which can be used in the present embodiment include a semiconductor memory, HDD and the like provided in a computer 12 installed in the vehicle. In this case, a part of the computer 12 can be made to function as the controller 5 and a display connected to the computer 12 can function as the display 6.

Instead of using the structure described above, a computer provided in a laboratory or the like may be used as the controller 5. In this case, a USB memory or a removable HDD, connectable to the computer 12 installed in the vehicle, can be used as the memory 3 so that the memory 3 in a state where it has stored the data acquired during the travel of the vehicle is removed from the computer 12 installed in the vehicle and then connected to the computer provided in a laboratory or the like.

In the present embodiment, a sensor utilizing GPS (Global Positioning System) can be used as the travel position sensor 1. By using such a sensor, positions of the construction vehicle during travelling can be continually acquired in a simple and easy manner.

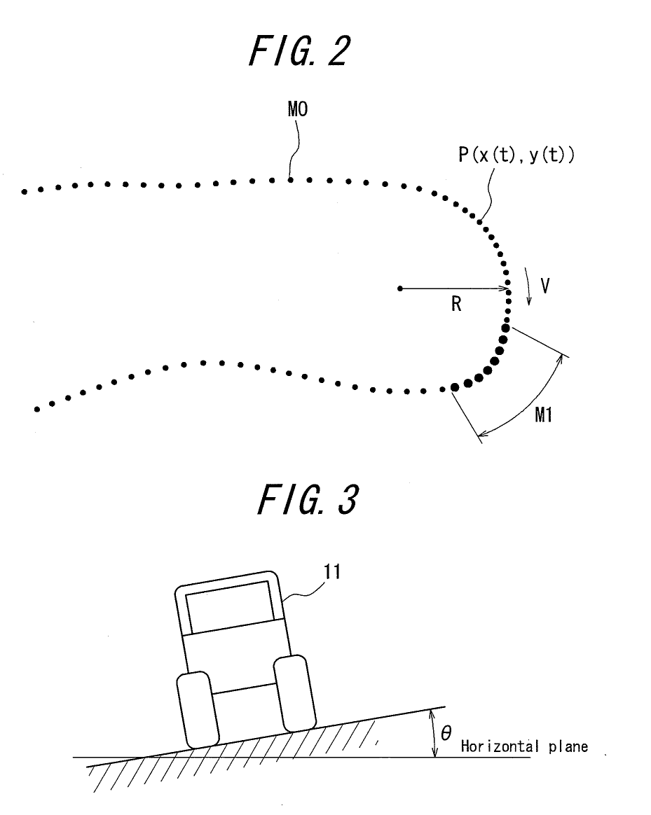

In the first embodiment of the present invention, the acceleration sensor 2 is adapted to be capable of measuring either acceleration in the left hand side direction or acceleration in the right hand side direction of the vehicle. FIG. 2 shows one example of image displayed by the display portion 6. This image shows a travelling path M0 including a curve portion. In the travelling path M0, a portion thereof M1, where acceleration in either the left or right hand side direction of the vehicle is beyond the predetermined range, is displayed in a different color.

By the travel position sensor 1, there can be acquired a position x(t) in the latitude direction, a position y(t) in the longitudinal or meridian direction, and height h(t), which positions are acquired, with e.g. a predetermined time interval Δt, along a travelling path on which the investigation vehicle 11 has traveled. Accordingly, by plotting a coordinate P(x(t), y(t)) on a horizontal plane for time t⁰, t^{0+Δt}, t^{0+2Δt}, . . . on the display portion 6, a travelling path M0 can be graphically expressed on the basis of such data. Further, the vehicle speed between two points on the travelling path M0 can be obtained by the formula (1) below.

$$v = \frac{{\sum }_{i = 1}^{n} {( \begin{matrix}{( {x ( {t}_{1} + i \cdot Δ t )}^{2} - x ( {t}_{1} + ( i - 1 ) \cdot Δ t ) )}^{2} + \\ {( {y ( {t}_{1} + i \cdot Δ t )}^{2} - y ( {t}_{1} + ( i - 1 ) \cdot Δ t ) )}^{2}\end{matrix} )}^{1 / 2}}{n \cdot Δ t} \qquad ( 1 )$$

Further, from the acceleration data α(t), there can be extracted a time range ts-te, during which the acceleration data α(t) is out of a predetermined range which has been set as the normal range. By plotting all of the horizontal plane coordinates P(x(t), y(t)) (t=ts-te) corresponding to the time range ts-te by using a different mark on the travelling path M0, a portion M1 of the travelling path, corresponding to an abnormal acceleration range, can be displayed on the travelling path M0 and presented as a candidate of the maintenance required travelling path portion which needs correction of the bank gradient angle.

Provided that the vehicle speed is V, the acceleration α in either the left or right hand side direction of the vehicle can be calculated according to the formula (2) below. In other words, it is possible to obtain from the formula (2) the minimum value of the bank gradient angle θ (see FIG. 3) at which acceleration reliably remains not larger than a predetermined value (e.g. preferably less than 0.05 g).

α=V²/R−g· tan θ|

In the formula (2), R represents the radius of curvature of a curve. This radius of curvature R can be obtained either by calculation based on the data of the coordinate P(x(t), y(t)) (t=ts-te) on a horizontal plane or from a graph obtained by plotting the horizontal plane coordinates P(x(t), y(t)).

The existing value R is maintained as the radius of curvature of the portion of the travelling path having a curve in the foregoing descriptions. However, alternatively, the prior art problems described above can also be solved by increasing the radius curvature of the curve. In this case, the bank gradient angle is first set at either the present angle or a new angle and then a new value of the radius of curvature of the curve is calculated.

In the present embodiment as described above, provided that the vehicle is basically driven at the speed V as the predetermined and prescribed speed, the approach speed at which the vehicle drives through a curve can be compared, on the basis of the formula (1) described above, relative to the predetermined and prescribed speed, i.e. the limit speed.

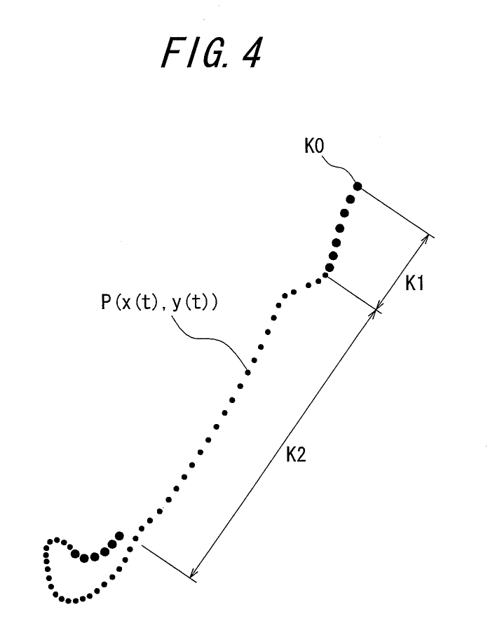

FIG. 4 is a view showing a travelling path K0 along which the investigation vehicle 11 has been driven in a second embodiment. A system for supporting maintenance of a travelling path for a construction vehicle of the second embodiment is substantially similar to that of the first embodiment, except that the acceleration sensor of the former measures acceleration α(t) applied in either the upward or downward direction of the vehicle 11. The travelling path K0 can be obtained by plotting a horizontal plane coordinate P(x(t), y(t)), based on the data from the travel position sensor 1 of the investigation vehicle 11, for time t⁰, t^{0+Δt}, t^{0+2Δt}.

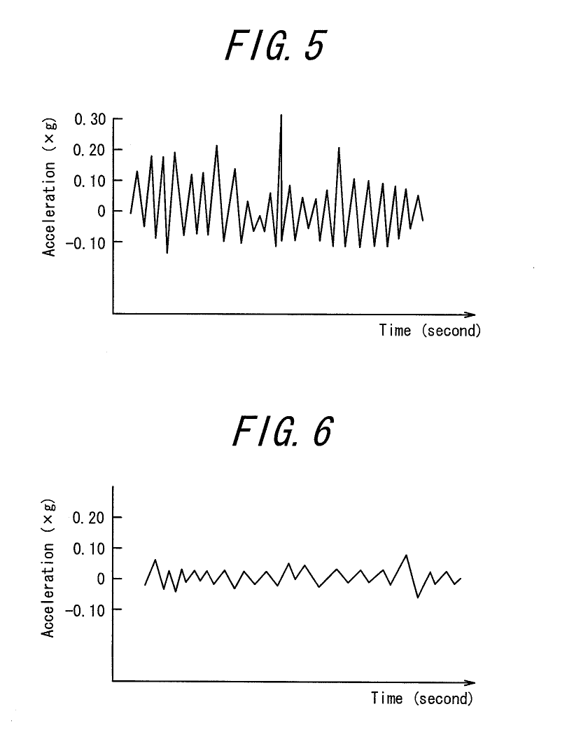

Temporal changes of the acceleration α(t) in one travelling path portion K1 and another travelling path portion K2 of the travelling path K0 of FIG. 4 are shown as graphs (time is taken along the X-axis) in FIG. 5 and FIG. 6, respectively. The temporal changes in acceleration shown in FIG. 5 and FIG. 6 are obviously different from each other. The portion K2 of the travelling path is smooth and exhibits relatively small changes in acceleration in the upward/downward direction, while the portion K1 of the travelling path exhibits a relatively large changes in acceleration in the upward/downward direction. From these results, it is understood that the portion K1 of the travelling path has relatively severe irregularities on the road surface thereof and thus needs a significant maintenance operation.

Examples of an index for indicating the magnitude of such irregularities of a road surface include the magnitude of temporal change in acceleration, the maximum value of acceleration observed during a unit time, and the like. In this case, as in the first embodiment, the portion K1 of the travelling path corresponding to an abnormal acceleration range can be displayed as a range of the travelling path portion K1 which requires maintenance by plotting on the travelling path K0 the horizontal plane coordinates P(x(t), y(t)) (t=ts-te), corresponding to the time range ts-te during which the aforementioned index is out of the predetermined normal range, by using a mark different from other coordinates.

Further, when it turned out that plural portions of the travelling path require maintenance, the magnitudes of irregularities of the respective travelling path portions can be judged on the basis of the aforementioned acceleration data. As a result, it is possible to present which portion of the travelling path should preferentially receive maintenance.

1. A system for supporting maintenance of a travelling path on which a construction vehicle travels, comprising:
a travel position sensor provided in the construction vehicle, for continually acquiring travel position data of the construction vehicle;
an acceleration sensor provided in the construction vehicle, for continually acquiring data of acceleration applied to the construction vehicle;
a memory provided in the construction vehicle, for storing data acquired by the sensors; and
a controller for reading the travel position data out from the memory to express the travelling path graphically, mapping the acceleration data on the travelling path thus graphically expressed, and specifying a portion of the travelling path corresponding to the acceleration data out of a predetermined, given range of acceleration condition, as a maintenance-required travelling path portion.

2. The system for supporting maintenance of a travelling path for a construction vehicle of claim 1, wherein the acceleration sensor is adapted to acquire data of acceleration in either the left hand side or the right hand side direction of the construction vehicle.

3. The system for supporting maintenance of a travelling path for a construction vehicle of claim 2, wherein the predetermined, given range of acceleration condition is 0.05 G or less.

4. The system for supporting maintenance of a travelling path for a construction vehicle of claim 2, wherein the controller is adapted to calculate a radius of curvature of the maintenance-required travelling path portion, based on the travel position data thereof, and obtain, based on the radius of curvature thus calculated and a predetermined, prescribed vehicle speed at which the vehicle is supposed to run on the maintenance-required travelling path portion, either a bank gradient angle at which acceleration in either the left hand side or the right hand side of the vehicle can be suppressed within the predetermined range of acceleration condition or a new combination of a bank gradient angle and a radius of curvature of the maintenance required travelling path portion.

5. The system for supporting maintenance of a travelling path for a construction vehicle of claim 1, wherein the acceleration sensor is adapted to detect acceleration in either the upward direction or downward direction of the construction vehicle.

6. The system for supporting maintenance of a travelling path for a construction vehicle of claim 3, wherein the controller is adapted to calculate a radius of curvature of the maintenance-required travelling path portion, based on the travel position data thereof, and obtain, based on the radius of curvature thus calculated and a predetermined, prescribed vehicle speed at which the vehicle is supposed to run on the maintenance-required travelling path portion, either a bank gradient angle at which acceleration in either the left hand side or the right hand side of the vehicle can be suppressed within the predetermined range of acceleration condition or a new combination of a bank gradient angle and a radius of curvature of the maintenance-required travelling path portion.
